(19) United States
(12) Patent Application Publication
(10) Pub. No.: US 2002/0080349 A1
(43) Pub. Date: Jun. 27, 2002

(54) Sample chamber for use in analytical instrumentation

(76) Inventors: Thomas M. Armstrong, Santa Clara, CA (US); John Lytle, Santa Cruz, CA (US); John S. Bashkin, Fremont, CA (US)

Correspondence Address: AMERSHAM BIOSCIENCES, PATENT DEPARTMENT, 800 CENTENNIAL AVENUE, PISCATAWAY, NJ, 08855, US

(21) Appl. No.: 09/746,361

(22) Filed: Dec. 22, 2000

(51) Int. Cl. G01N 1/10

(52) U.S. Cl. 356/246

(57) ABSTRACT

A tube or chamber optimized for applications as part of an optical system includes an optically transmissive elongate tubular body having an elongate tubular body wall including an interior surface and an exterior surface. The interior surface of the tubular body wall defines an elongate bore for containment or transport of a sample material to be analyzed. The body wall further includes a first portion, through which incident radiation passes, having a non-uniform thickness about the sample passageway so as to optimize optical coupling therethrough.

### FIELD OF THE INVENTION

The present invention relates generally to an optically transparent tube or chamber used in analytical instrumentation, and more particularly to a family of transparent fluid conduits that employ non-cylindrical surface shapes, and non-symmetric geometries.

### BACKGROUND OF THE INVENTION

The art has seen various fluid conduits employed for transporting a fluid within an analytical instrument. In certain applications, the fluid is analyzed within the fluid conduit as it passes therethrough. For example, capillary tubes are employed in many applications in analytical chemistry, electrophoresis, absorption analysis, flow cytometry, microfluidics, and so on. A liquid sample is typically delivered into the bore of a capillary and this sample is interrogated in some way so as to generate analytical information concerning the nature or properties of the sample. For example, a laser beam may excite the sample that is present in the bore of the capillary, with the emitted fluorescence energy representing the signal information.

From an optical perspective, the capillaries in the prior art have been passive components whose main function is to transport the sample medium to a location where it may be analyzed. A typical capillary is comprised of an elongate cylindrical glass rod having a hollow co-axial cylindrical bore of smaller diameter, also circular in cross-section, in which the sample to be analyzed is placed. With the sample in place, an interrogation beam is aimed through the analysis window of the capillary, in a plane transverse to the capillary longitudinal axis, so as to intercept the sample therein. The interrogation beam is normally subjected to some amount of aberration as it passes through the cylindrical wall of the capillary. Aberration is a byproduct of the refraction process, and this aberration may limit the efficiency of the illumination process, and also may limit or compromise the process of collecting and delivering the resultant signal energy to the photodetector. The diameter of the bore relative to the outer diameter of the capillary impacts these efficiency factors.

The inefficiencies of optical coupling into and out of the capillary bore may include a less-than-optimum dwell time of the illumination energy upon the sample. For example, as the interrogation beam scans across the capillary, part of the beam may be directed into the capillary wall without effectively illuminating the sample medium carried within the capillary bore. U.S. Pat. No. 5,483,075 to Smith has attempted to illuminate more efficiently by causing the interrogation radiation to dwell longer on the bore of a capillary as the illumination apparatus is scanned across the capillary at a constant speed. Accomplishing this task requires a complex mechanism that is subject to alignment and durability problems. The shaped capillary under interrogation here can accomplish this descanning of the probe beam by optical means, with no need for a complex assembly of moving mechanical parts.

The prior art has also taught that the fluid passageway of a capillary may be shaped so as to minimize fluid flow turbulence therethrough. U.S. Pat. No. 5,324,413 to Gordon discloses varying the cross-sectional shape of the fluid passageway so as to minimize fluid flow turbulence and to minimize temperature gradients within the fluid sample that may cause undesirable eddy currents. Gordon teaches forming a fluid conduit having a fluid passageway with an exaggerated rectangular cross-section. The interrogation signal is directed though the planar face of a bulb built into a portion of the capillary. Gordon makes no mention of the optical properties of the conduit. U.S. Pat. No. 5,228,969 to Hernandez discloses the attachment of a reflective surface along the wall of a cylindrical capillary to reflect an interrogation beam passing through its core, thereby increasing the amount of interrogation radiation impinging upon said core. The reflective surface is provided as an addition to a cylindrical capillary with a concentric cylindrical bore, in order to improve its optical efficiency.

Capillaries have been fabricated with non-circular cross-sections by Polymicro Technologies Inc. (Phoenix, Ariz.), however, the approach has been to create forms with planar surfaces instead of cylindrical ones. This approach works against optical coupling efficiencies, as the planar window surfaces cause a lower effective numerical aperture or solid angle of signal radiation to be delivered out of the capillary for capture by the detection system. Furthermore, planar optical windows reduce the duty fraction in any detection systems that interrogate the contents of the chamber using a scanned probe beam; and this is a disadvantage as well for non-scanned detection apparatus, as it couples a smaller beam size into the sample in the chamber or capillary.

To date, therefore, the art has not disclosed shaping the tubular wall of the capillary itself to deliberately optimize the effect of the reflector, or of the refracting surfaces to direct the incoming interrogation beam to the sample for greatest effect, or to optimally couple the outgoing signal beam with the optical train feeding the detector, or to cause the refracting and reflecting surfaces to work cooperatively together, in an integrated and optimized catadioptric system. There is therefore a need in the art for a simple and economical mechanism to increase the scanning dwell time of the interrogating beam; improve the effectiveness of both the direct and reflected interrogation radiation delivered to the sample; as well as to increase the effective numerical aperture of the signal beam delivered to the collection optics. There is a further need in the art to provide a capillary whose shape and dimensions are specifically tailored to play an active rather than passive role in the analytical optical system in which it is employed.

### SUMMARY OF THE INVENTION

In view of the needs of the art, the present invention provides an optical interrogation chamber or conduit that is designed to be an active component of an optical system in an analytical instrument. A preferred embodiment of the present invention takes the form of an elongate electrophoresis capillary useful in analyzing DNA and protein samples. The capillary of the present invention has an optically transmissive elongate tubular capillary body with an elongate tubular capillary body wall. The body wall includes an interior surface and an exterior surface, whereby the interior surface of the capillary body wall defines an elongate bore, or sample passageway for containing a biological sample. The body wall includes a first portion through which incident light passes. The thickness of the first portion of the capillary body wall is non-uniform about the sample passageway so as to tailor the delivery of incident interrogation radiation into, or to optimize the capture of signal radiation exiting, the sample passageway. Methods for making the present invention are also disclosed.

The coupling of interrogation radiation into a capillary might be improved by: (1) displacing the bore with respect to the outer surface of the capillary; (2) forming the entrance surface into an optimized, more complex shape than a simple cylinder; (3) reflecting the interrogation energy striking the rear surface of the capillary so as to enter the core; (4) shaping and positioning the reflector to optimize effectiveness of the second-pass interrogation; and (5) employing planar surfaces on the capillary to minimize optomechanical alignment errors relative to the optical systems coupling with it. The choice of refractive index, and the ratio of inner to outer capillary dimension determine to a great extent the benefits of implementing these design modifications.

Generally, the technology of capillary manufacture does not dictate that the devices be strictly cylindrical, or that they possess exact circular symmetry. In most instruments employing capillary-type sample containment, signal processing efficiency is related in some way to the flux of the interrogation beam radiation that may be delivered to the sample chamber, and to the amount of signal energy that can be collected and delivered to a detector. The present invention teaches the benefits. in terms of interrogation efficiency and signal collection efficiency, of making any or all of several modifications to the standard capillary configuration. Frequently, interrogation radiation may be delivered to the capillary in collimated fashion, but signal energy will be radiated into a large angular swath. Naturally, modifications to the capillary geometry that affect interrogation efficiency may also alter the efficiency of collection of signal radiation, and so it is necessary to consider these tradeoffs in the process of altering the symmetric cylindrical geometry of a traditional capillary. The choice of capillary design parameters may, in fact, be driven by various instrumental considerations, such as the scanning mechanism, number of capillaries, detector characteristics, choice of interrogation light source, properties of the analyte, data processing algorithms, and so on.

By varying the cross-sectional design parameters of the capillary, the present invention provides a design optimized for optical performance within an analytical system. The capillary of the present invention is, in fact, an active component in an optical system for analyzing the contents of the capillary bore. The capillary design parameters may be varied to provide a capillary exhibiting improved efficiency in interrogation and/or signal radiation collection. Moreover, the present invention discloses various optimized capillary designs embodying the principles taught herein, including capillaries having a double-pass configuration and designs incorporating various combinations of individual contributions identified in this disclosure. The capillaries of the present invention may be formed to direct an interrogation beam to or about a selected target portion of the capillary. Furthermore, the present invention enables the creation of new instrument configurations, detection modes, and scanning arrangements not realizable using ordinary capillaries.

As some applications are designed to detect signal energy from the same side of the capillary that is illuminated by interrogation energy, it is possible to intercept interrogation energy that has passed through the sample in the capillary bore, and reflect it back through the bore. In general, the rear surface of the capillary can be optimally shaped and rendered reflective, so that a portion of the first-pass interrogation energy will traverse the bore a second time, thereby increasing the total interrogation radiation delivered to the sample therein. The shape and reflectance properties of this back-reflector are subject to optimization to suit the particular interrogation and detection scheme.

The present invention combines the modifications described above into capillary configurations that collect and utilize interrogation radiation much more effectively than the traditional capillary employing concentric, entirely cylindrical outer and inner surfaces. One embodiment of the present invention provides a capillary utilizing an acylindrical entrance surface to direct interrogation beam radiation to a displaced bore so as to focus the radiation at the rear outer surface of the capillary. Such a configuration reflects interrogation radiation through, for example, a central point in the core to travel back upon itself, retracing its input path and essentially doubling the effective amount of interrogation radiation delivered to the bore.

When the incident interrogation beam is precisely focused upon the outer rear surface of the capillary, the curvature of this surface has no effect upon the ray angles reflected from it. Therefore, this rear surface might well be entirely flat, a useful mechanical feature if multiple capillaries are to be juxtaposed and aligned in an array, as is common in capillary array electrophoresis. A planar rear surface enables all capillaries in an array to be rotationally aligned with great precision, minimizing the ill effects that may occur if the interrogation energy enters from a non-zero angle with respect to the optical axis of the cross-section of the acylindric surface. Similarly, the alignment of the exiting signal energy (with respect to the collection optics) is controlled by these alignment features on the exterior of the capillary. A capillary may, in fact, include opposed planar sides for cooperatively aligning adjacent capillaries with respect to one another and to optical trains designed to deliver interrogation radiation or collect signal energy.

As well as improving the coupling efficiency of interrogation energy into the bore of the capillary, the invention provides for enhanced coupling of signal energy out of the bore and into to the signal collection optical train. The careful design and construction of the window that couples the energy out of the bore can make more signal energy available for detection, and the proper use of reflectors can deliver energy to the detection optical train that would ordinarily be lost from conventional capillaries.

Beyond improvements in the efficiency of the optical coupling with the capillary bore, the invention provides benefits of modifying the properties of scanned interrogation, accomplishing optomechanical scan functions with optical features of the capillary tube. Capillary features can thus replace mechanical devices, improve spatial and temporal aspects of the interrogation and detection process in the analytical instrument, as well as provide radiometric efficiency gain in both interrogation and signal collection.

### BRIEF DESCRIPTION OF THE DRAWINGS

FIG. 1 depicts a typical capillary of the prior art.

FIG. 2 depicts the ray paths of a collimated beam interrogating the capillary of FIG. 1.

FIG. 3 depicts the ray paths of an interrogating beam incident upon the capillary of FIG. 1, including those paths that bypass the bore altogether.

FIG. 4 shows a first embodiment of the present invention, a capillary having a body wall of non-uniform thickness about the bore, comprised of a substantially cylindrical outer surface and an axially-displaced cylindrical bore.

FIG. 5 shows another embodiment of the present invention, a capillary possessing a body wall having non-uniform thickness about the bore, accomplished by utilizing an acylindrical outer surface.

FIGS. 6A-H depicts alternate embodiments of the capillary of FIG. 5 in which the capillary constructional parameters are tailored to focus the interrogation energy at various locations within the capillary.

FIG. 7 presents the embodiment of FIG. 6C further employing a retro-reflector to return both interrogation and signal radiation directly back through the capillary bore, while acting in concert with the refracting window to provide collimation of the signal radiation leaving the capillary.

FIG. 8 depicts the capillary of FIG. 6C shaped to substantially focus all interrogation energy at the central, longitudinal axis of the capillary bore, as a collimated interrogation beam is scanned across the capillary.

FIG. 9 depicts an acylindric capillary providing improved numerical aperture collection of signal energy from a point within the bore.

FIG. 10 depicts still another embodiment of the present invention employing a geometry designed to substantially focus interrogation energy upon the rear outer surface of the capillary.

FIG. 11 depicts the embodiment of FIG. 10, with a reflective surface added to a portion of the outer surface of the capillary body, providing double-pass, swept interrogation.

FIGS. 12A-B depict an additional embodiment of the present invention, where the capillary has a planar or shaped reflective surface, for providing double-pass interrogation radiation through the sample passageway. FIG. 12B further shows the additional advantage of a retro-reflector returning signal radiation back in the direction of the detection optics.

FIG. 13 depicts parent signal source points a and b, and satellite signal source points c and d created by reflection, for a capillary of the present invention.

FIG. 14 depicts a capillary of the present invention that reduces the separation of the parent and satellite emission sources by diminishing the thickness of the capillary wall separating the bore and the rear exterior capillary surface.

FIGS. 15A-B depict acylindric capillaries having bilateral symmetry, which facilitates assembly of the capillaries of the present invention into arrayed assemblies

FIG. 16 depicts a plurality of capillaries of FIG. 15B, ganged to form an array of rotationally-aligned capillaries for use in an analytical instrument.

FIG. 17 depicts a capillary providing an optical chamber of the present invention in which the interrogation beam is distributed through the depth of the sample, providing a uniform distribution of the interrogation energy onto the sample. This weighting applies whether scanning a small interrogation beam or interrogating with a broad beam of optical radiation.

FIG. 18 depicts a capillary with interrogation and signal beams traveling through separate, roughly orthogonal portions of the capillary wall, with the wall properties optimized independently for these two functions.

FIG. 19 depicts an alternate embodiment of the present invention providing excitation directed at 90 degrees to the emission collection vector, showing three flat surfaces provided for aligning the capillaries within the array.

### DETAILED DESCRIPTION OF THE INVENTION

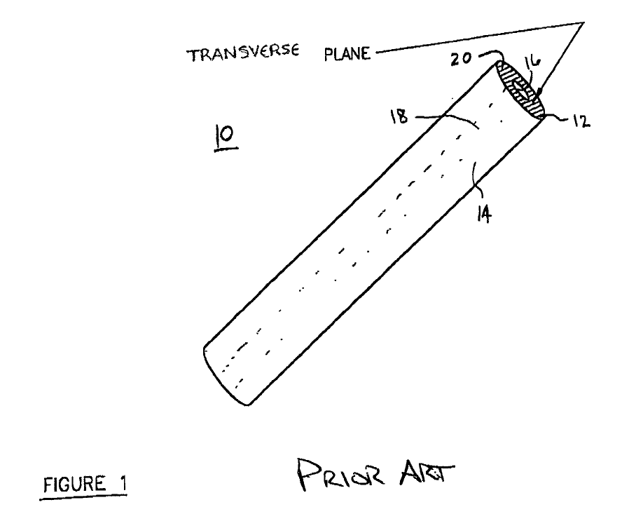

FIGS. 1-3 depict a typical capillary tube 10 of the prior art. Capillary 10 includes an elongate tubular body wall 12 having a cylindrical exterior surface 14, a cylindrical interior surface 16 which defines an elongate cylindrical sample passageway 18 for containment of a sample medium, or for sample transport or migration processes. A transverse plane 20 is depicted to show the plane of travel of a traversing interrogation beam, that interrogates the sample contained within sample passageway 18. Energy emitted or transmitted by the sample (or scattered, reflected, polarized, modulated or otherwise altered by the sample) may be detected so as to characterize the sample. Often the interrogation is performed so as to characterize how the signal radiation from the sample changes over time.

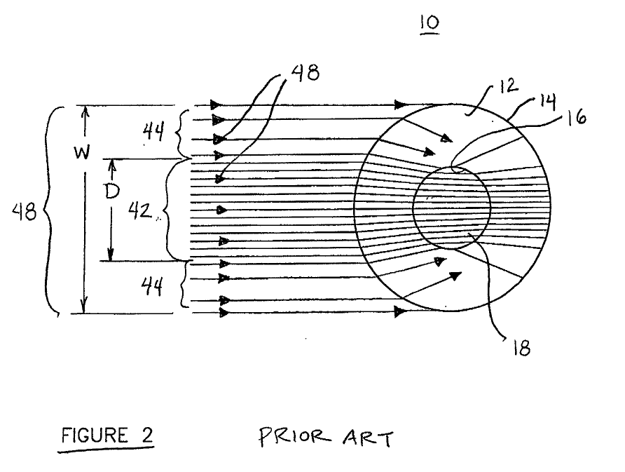

Referring now to FIG. 2, the ray paths of incident interrogation radiation 42 are depicted, showing the illumination of the capillary by collimated radiation. Each ray may also represent the path of a laser beam as it is scanned or swept across the capillary, as is often practiced with arrays of capillaries. The efficiency of the interrogation process is, for the most part, limited by the transverse extent or dimension of the group of rays 42 striking the capillary that can be coupled effectively into the sample passageway 18 of capillary 10. This interrogation beam acceptance dimension D is, in turn, related to the relative diameters of the outer and inner diameters of the capillary, and to the refractive indices of the capillary material and sample medium.

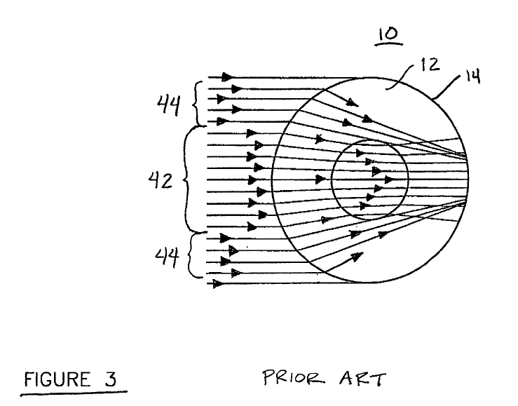

As the interrogation efficiency of a capillary is directly related to the fraction D/W of these interrogation rays 42 that can be delivered to the bore of the capillary, any modification to the capillary design that increases the fraction of incident rays that actually couples into the bore can conceivably improve efficiency. Ideally, all energy 48 that impinges upon the capillary tube would pass through the bore, thereby improving interrogation of the sample medium within. In reality, of course, some of the energy that is refracted into the capillary may bypass the core, and therefore is ineffective for interrogation. FIG. 3 depicts this bypass radiation 44 that is refracted by body wall 12, but which fails to encounter the sample passageway 18.

As stated hereinabove, the coupling of an interrogation beam into a capillary might be improved by: (1) moving the bore away from the centerline of the outer diameter; (2) making the entrance surface a better optimized, more complex shape than a simple cylinder; (3) reflecting the interrogation energy striking the rear surface of the capillary back through the bore; (4) focusing the interrogation radiation upon the rear outer surface of the capillary; or (5) employing a flat rear surface to minimize optomechanical alignment errors. The choice of refractive index value for the capillary wall material, and the ratio of inner to outer diameter determine to a great extent the benefits of implementing the design modifications mentioned above.

The axisymmetric nature of existing capillary designs is probably based upon tradition and ease of manufacture, since there is no inherent reason that non-axisymmetric or non-cylindrical (acylindric) shapes should not be employed. If the outer and inner diameters of the traditional capillary are preserved, but the capillary bore is simply displaced rearward (away from the incoming radiation) with respect to the axis of the outer cylinder diameter, raytrace analysis demonstrates that interrogation coupling efficiency improves significantly. Depending upon the refractive index of the capillary wall material, efficiency improvements in excess of 20% may be realized as a result of relatively minor displacement of the bore with respect to the central axis of the outer diameter.

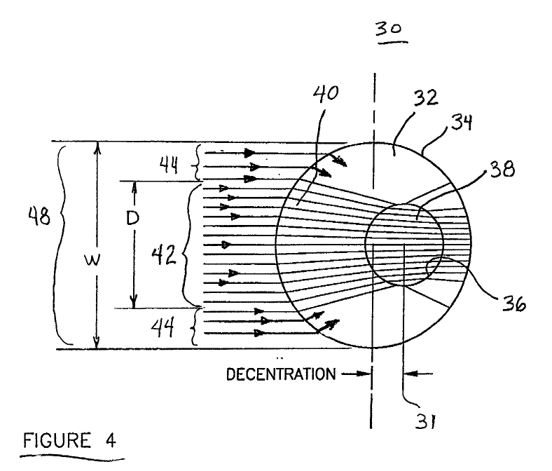

FIG. 4 depicts in cross-section a capillary 30 of the present invention. The capillary of the present invention may be formed of any refractive material having acceptable transmission properties and is desirably formed from fused silica, a material desirable for its high purity, superior transmission in the blue and violet portions of the wavelength spectrum, and its freedom from fluorescence. The refractive index of fused silica is approximately 1.463. For modeling purposes, the medium in the capillary bore is assumed to be water, with a refractive index of 1.33. Desirably, fused silica capillary 30 is intended to function at a wavelength of 488 nanometers, although the design prescription could be optimized at any wavelength for which the transmission properties of the selected material are acceptable.

Capillary 30, and all of the capillaries of the present invention, are contemplated to be scalable for use in most any optical analysis application. The present invention provides an optical analysis chamber capable of supporting a material sample to be analyzed and of focusing an interrogation beam to or about a desired location within the chamber or about other locations within or beyond the capillary. The optical advantages described for capillaries of the present invention are readily scalable in proportion to provide optical analysis chambers of larger dimensions. The optical chambers of the present invention may be employed with optical interrogation and detection systems including, but not limited to, those utilizing electromagnetic radiation, acoustic radiation, florescence emission, absorption, scatter, optical phase detection, state of polarization, or any other method known in the art. In general terms, an interrogation beam is directed to a target location within the optical analysis chamber of the present invention. Upon striking the sample within the chamber, the interrogation beam is transformed or altered to produce a signal which may be analyzed for the presence or absence of information determinative of a specific characteristic of the sample.

Capillary 30 includes an elongate tubular body wall 32 having a substantially cylindrical exterior surface 34 and a substantially cylindrical interior surface 36. Interior surface 36 defines an elongate cylindrical sample passageway, or bore, 38 for containment of a sample material. Interior surface 36 is shown to be displaced with respect to exterior surface 34. By de-centering passageway 38 with respect to exterior surface 34, capillary 30 provides improved optical properties for interrogating a sample within passageway 38, by including more of the rays 44 that would ordinarily bypass the core as rays 24 do in FIG. 3. Body wall 32 includes a first portion 40 upon which incident interrogation radiation 42 is refracted through sample passageway 38. First portion 40 of body wall 32 is shown to have a non-uniform thickness about sample passageway 38 which increases the usable width W of the interrogation rays 42, and thereby increases the dwell time of any scanned interrogation beam, as well the duty fraction of the scan across the capillary. Each ray 48 represents a beam position as the interrogation beam traverses the capillary. In a similar fashion, a large interrogation beam can be used—a beam as relatively wide as dimension W can couple energy into the core for this ‘enhanced duty fraction’ capillary. First portion 40 of body wall 32 also works to increase the collectable angular subtense of energy originating within sample passageway 38 and traveling outward through body wall 32.

In a similar fashion, optical efficiency may be adjusted by altering the ratio of the outer diameter of the capillary to that of the inner diameter. In general, decreasing the wall thickness by reducing the outer dimension has the effect of intercepting a larger fraction of the incident interrogation rays 48, in the ratio of dimension D to dimension W, the duty fraction. The manufacturing process employed to form the capillary tube will, naturally, limit the practical range of innerlouter diameter ratios. In comparing the performance of different capillary designs, the size of the bore is viewed as a constant. This makes the sample volume constant and allows meaningful quantitative comparisons of capillary performance.

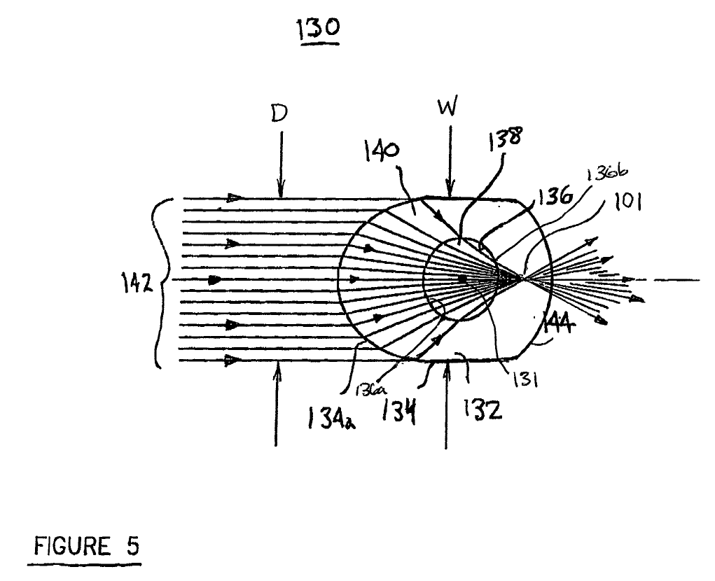

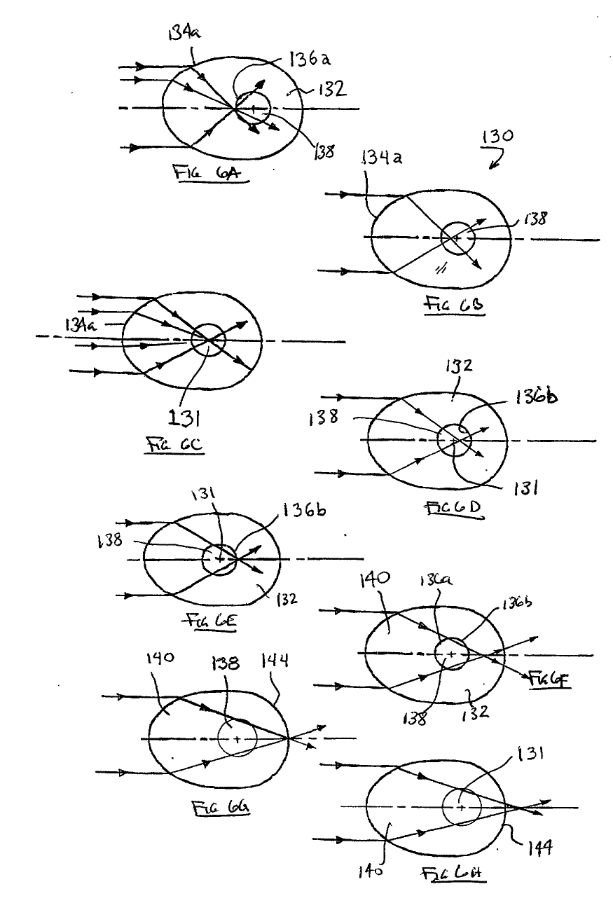

While changes to the symmetry of an otherwise cylindrical capillary make possible the alteration of the optical behavior in sample interrogation and signal collection, it is also possible to modify the cylindrical character of the inner or outer surfaces of the capillary to create additional optical advantages. Referring now to FIG. 5, capillary 130 is formed from a similar material as capillary 30 and like numbering represents like components, as for all embodiments of the present invention. Capillary 130 includes a tubular body wall 132 having an exterior surface 134 and a substantially cylindrical interior surface 136. Interior surface 136 defines an elongate and approximately cylindrical sample passageway 138 for containing a sample medium. Body wall 132 includes a first portion 140 which is illuminated by incident interrogation radiation 142. This interrogation energy is refracted through sample passageway 138. The first portion 140 of body wall 132 is non-uniformly thick about sample passageway 138.

Exterior surface 134a of first portion 140 is desirably acylindrical. Its contour is established taking into consideration the refractive index of the material forming body wall 132 and the desired interrogation beam paths to be taken through sample passageway 138. Exterior surface 134a is shown to be a curvilinear surface having a generally elliptical shape, although other more complex surface shapes are contemplated to be within the scope of the present invention, a possibility that those skilled in the art will appreciate. Exterior surface 134a is desirably formed to direct substantially all of the incident radiation through sample passageway 138, to converge in the vicinity of a predefined location 101 therebeyond. Incident radiation 142 is shown converging toward a location beyond passageway 138 but before the rear surface 144 of capillary 130.

By rendering exterior surface 134a acylindric, the character of a set of interrogation rays refracted toward the bore may be specially tailored, and the input beam acceptance width D adjusted, thereby improving coupling efficiency in interrogation. Considering the case where the diameter of the interrogation beam is small in comparison to the capillary bore diameter, then the duty fraction and dwell time, as the beam is scanned to traverse the capillary, can be maximized by altering the exterior surface 134a of the capillary to take on, for example, the profile of a conic section. Capillary 130 also realizes improvements in interrogation efficiency by increasing the front side thickness of the capillary, so that additional lens power is created according to the “thick lens” equation known to those skilled in the lens design art. These features of capillary 130 enhance the focusing from the entrance surface, and result in a longer interrogation beam dwell time on the core, and/or in a larger useable scan window, depending on the nature of the particular interrogation and detection methods employed. Raytrace studies demonstrate that, for fused silica capillaries and water-based sample media, interrogation coupling efficiency can be improved as much as 80% by displacing the capillary bore away from entrance surface 134a, increasing the front thickness 140 of the capillary tube, and modifying the shape of the entrance surface to be acylindric in a carefully prescribed manner.

The abrupt curvature variation necessary to create such a capillary configuration requires a mathematical model that permits high-degree deformations to be represented. Although numerous models exist for representing such a surface prescription, one in fairly common usage describes the entrance surface contour, in the transverse plane-or Y-Z plane represented by axes 199 and 154, as the summation of terms containing vertex curvature C, a conic deformation term K, and other high-degree, power series deformation terms D, E, F, G, and so on. This contour may be expressed, for example, as a sum of the terms:

ACYLINDRIC PROFILE Z={CY²÷└1+\sqrt{(K+1)(C²Y²)}┘}+DY²+EY⁴+FY⁶+GY⁸+HY¹⁰ Equation (1)

The present invention also contemplates employing surface shapes approximating a profile derived from Equation (1) as well. For example, the surface of a capillary of the present invention may include a plurality of non-continuous curved or planar sections that, in the aggregate, function to focus an interrogation beam or to increase the NA gain for the outcoming signal. The key feature of the acylindrical surface of the present invention is to increase dwell time or numerical aperture of the optical chamber.

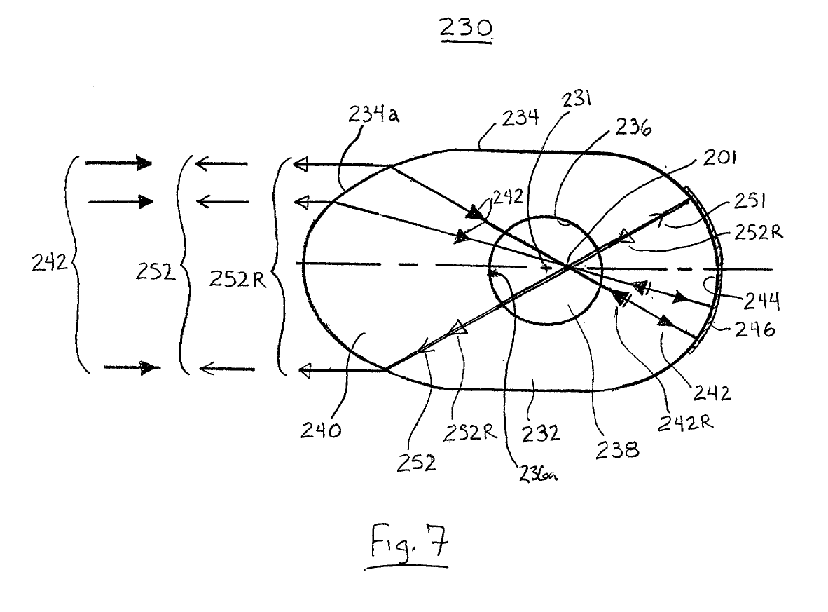

FIGS. 6A-H depict the ability to shape capillary 130 so as to direct an interrogation beam towards different selectable target areas of the capillary. If the capillary entrance surface shape and the wall thickness separating the entrance surface and the bore are both considered to be free design variables in the optimization of the capillary configuration, several distinct and unique design solutions are possible. For example, the capillary design parameters may be chosen so that the interrogation radiation is directed through the exterior surface 134a and is brought substantially to focus at a location near the first interior surface portion 136a of tubular body wall 132 prior to encountering bore 138, as in FIG. 6A, or just after passing into bore 138, as in FIG. 6B. Alternatively, capillary 130 may be designed so as to substantially focus all the interrogation radiation about the center 131 of sample passageway 138, as seen in FIG. 6C. A small adjustment in the constructional parameters can, alternatively, result in interrogation radiation being brought substantially to focus at a location near the second interior surface 136b of tubular body wall 132 beyond the center 131 of the passageway 138, as in FIGS. 6D and 6E. FIG. 6F depicts forming first portion 140 to substantially direct interrogation radiation about a point beyond second interior surface portion 136b of tubular body wall 132 after passing through bore 138. FIG. 6G depicts the condition where first portion 140 directs incident radiation to substantially focus at a location near the rear surface 144 of tubular body wall 132 beyond sample passageway 138. FIG. 6H depicts the shaping of first portion 140 to focus interrogation radiation beyond the rear surface 144.

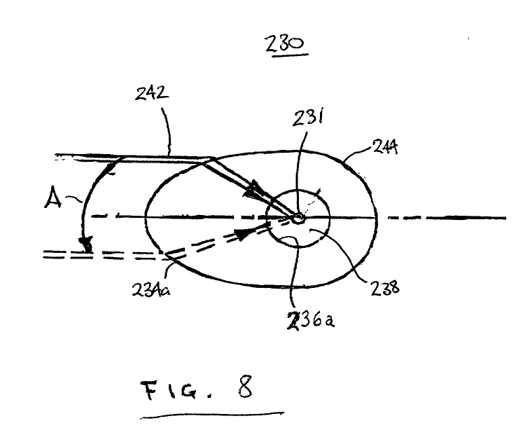

Oftentimes, interrogation energy which has impinged upon the sample medium in the capillary bore passes through and out of the capillary, where it is then trapped or dumped. Judicious modifications to the capillary design make it possible to intercept this interrogation energy (that has passed through the sample in the bore), and recycle it by reflecting it back toward the bore, or by retro-reflecting selected rays to precisely retrace their paths through the bore. If this is done, a portion of the first-pass interrogation energy will enter the bore a second time, thereby increasing the total amount of sample interrogated. If this enhancement is correctly implemented, optimizing the shape and location of the reflector, it is possible to nearly double the amount of sample intercepted by the interrogation beam. To implement this modification, the shaped rear surface is made highly reflective by the addition of a coating. FIG. 7 depicts the cross-section of another capillary 230 of the present invention illustrating this configuration. Capillary 230 includes an elongate tubular body wall 232 having an exterior surface 234 and a substantially cylindrical interior surface 236. Interior surface 236 defines an elongate cylindrical sample passageway 238 for containment of a sample medium. The body wall 232 includes a first portion 240 upon which incident interrogation radiation 242 impinges and is refracted through sample passageway 238 and to focus substantially to a point 201 within the core. Forming surface 234a to the proper shape to refract the interrogation rays to this focus provides improved optical efficiency for interrogating the sample, and other advantages can be derived from this design choice as follows.

Capillary 230 further includes a rear surface 244 opposite sample passageway 238 from first portion 240. A reflective surface 246 is formed, by any of the methods known in the art, on rear surface 244 so as to retro-reflect interrogation radiation rays 242 back on themselves 242R and through the sample passageway 238, passing again through point 201. The retro-reflected excitation rays 252R retrace back to emerge from the capillary traveling parallel to the interrogation rays 242. An additional benefit of this design geometry is that the sample-filled bore 238 is substantially reimaged upon itself by this reflective surface 244, thereby directing additional signal radiation to the detection optical train. For example, sample at location 201 emits signal radiation 251 and 252 in response to interrogation radiation 242. The signal ray 251 is retro-reflected by reflective surface 246 to travel 252R back through the core, joining signal ray 252, traveling then together out of the capillary and on toward the detection optical train. If the combined improvements in interrogation and signal collection efficiency are considered, such a design is capable of yielding a net performance improvement approaching 10 times more than the standard cylindrical design. This case of collimated interrogation rays and collimated signal rays also enables custom signal collection optical arrangements.

With careful choice of the shape of exterior surface portion 234a and of its spacing from bore 238, it is possible to induce substantially all collimated interrogation energy 242 to focus and pass through a point 201 near the central longitudinal axis 231 of bore 238. In view of the fact that this arrangement of constructional parameters focuses interrogation radiation rays 242 in the transverse plane very tightly within bore 238, there will occur very high flux densities about point 201 near bore axis 231. This center-weighted interrogation condition provides an advantage going beyond improved radiometric efficiency, by providing the capability to tune the spatial sensitivity of the detection system—in this case to emphasize sample in the center of bore 238. As well, this ability to change the scan characteristics by shaping the capillary provides useful optomechanical function along with optical efficiency gains.

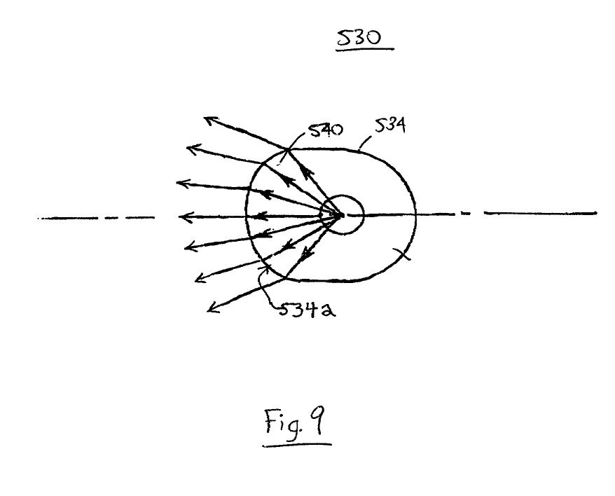

Since in this optical geometry there is no lens power present in any of the planes containing the longitudinal axis of the bore, this component of the interrogation radiation is not focused. Collimated radiation entering the capillary in this plane will enter the bore collimated as well. If a collimated interrogation beam 242 of relatively small diameter is scanned, as represented in FIG. 8 by the traverse of arrow A, across capillary 230, some portions of the sample will be interrogated for a brief moment, but that portion of the sample near bore longitudinal axis will be interrogated continuously. Further, in this transverse plane, signal radiation originating near the center of the bore 238 will travel so as to exit bore 238 essentially normal to the sample-fused silica interface at surface portion 236a, and will retrace the path of the interrogation radiation, thus leaving the capillary in a collimated condition. Signal radiation exiting in any plane parallel to the bore longitudinal axis 231 will encounter no optical power, and thereby exit capillary 230 in a divergent condition. Under these circumstances, in the transverse plane, the signal radiation 252 will retrace the path of the interrogation beam 242. This special capillary design feature makes possible the design of some uniquely configured collection optics. Additionally, since the signal radiation leaving the capillary is collimated in the transverse plane, sensitivity to capillary defocus, relative to the detection optical train, is very low in that plane.

The design techniques described above may be applied to the optimization of the collection of signal radiation as well. In some instrument designs, the duty fraction and dwell time of the interrogation beam are less important performance considerations than the numerical aperture (NA) in the transverse plane, of the signal radiation exiting the capillary. If this is the case, then the cross-sectional shape of the optimum capillary configuration may be quite different, as depicted in FIG. 9. The collection angle in any plane including the capillary longitudinal axis is, of course, unaffected by the cross-sectional shape of the capillary. However, capillary 530 employs a thinner frontal window at first portion 540 and a more blunt-shaped window surface 534a so as to make possible the collection of a swath of signal radiation rays whose NA exceeds 1.0 in the transverse plane.

By prescribing a shape possessing modest curvature near the axis, but strongly curved outer zones, signal energy leaving the bore in a large angular swath may be concentrated into a smaller angle, making possible the coupling of this energy into a lower NA collection optical system. Capillary 530 incorporates this design. Raytracebased optimization and analysis demonstrates that an in-core collection NA of 1.0 can be reduced to 0.7 to facilitate collection and imaging by an optical train designed for the lower NA acceptance. Proper choice of the coefficients C, K, D, E, F, and G in Equation (1) make possible improvements in signal energy collection efficiency of as much as 40% in some circumstances. In a capillary whose width is approximately 0.18 mm, the front thickness is 0.057 mm, while the bore diameter remains at 0.075 mm, and the central curvature of the front surface 534a is significantly reduced. Curvature in the outer zones of the window is dramatically increased, though, providing a net signal energy collection ‘NA gain’ of approximately 40%. The configuration of capillary 530 is produced by inserting the proper coefficients into Equation (1) above. The proper coefficients are: C=8.02106; K=1.80969; D=−2.25941; E=172.96; F=9340.7; G=1.506×10⁶; H=2.7816×10⁸.

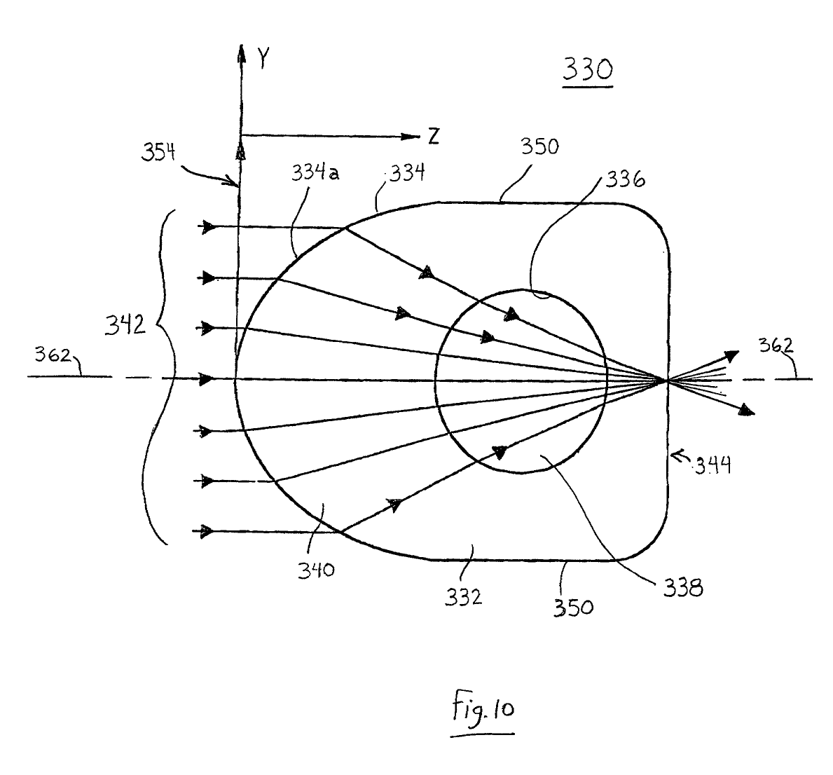

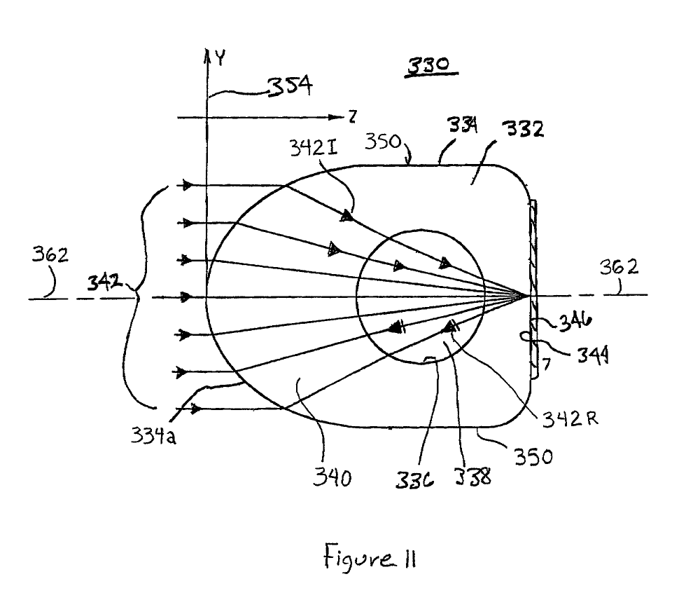

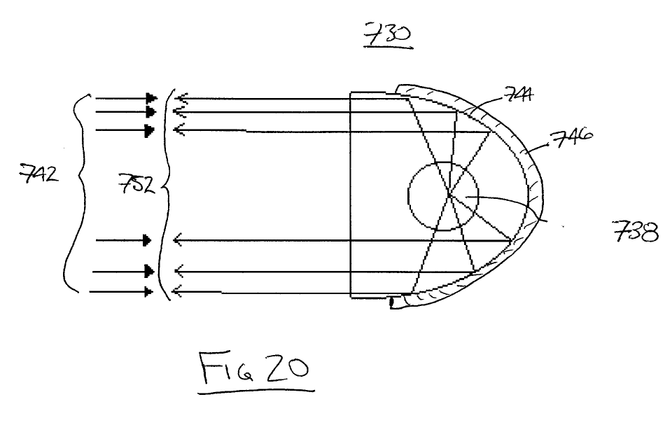

FIG. 10 depicts yet another capillary configuration 330 of the present invention. Capillary 330 includes an elongate tubular body wall 332 having an exterior surface 334 and a substantially cylindrical interior surface 336. Interior surface 336 defines a cylindrical sample passageway for containment of sample material. Body wall 332 includes a first portion 340 upon which incident radiation 342 of an interrogation beam impinges and is refracted through sample passageway 338. Exterior surface 334 includes a substantially planar rear surface 344 formed opposite sample passageway 338 from first portion 340. Exterior surface 334 of capillary 330 further includes oppositely spaced planar side surfaces 348 and 350, formed between surfaces 334a and rear surface 344. The side surfaces 348 and 350 and rear surface 344 may be employed to position or align a capillary of the present invention, either singularly or in a matrix of capillaries, such as along a mounting surface 356 in FIG. 19. The present invention contemplates that any coatings or surface treatments applied to the exterior surface of the tubular body will conform to the facets provided by surfaces such as 344, 348 and 350, so as to maintain the alignment feature provided thereby.

Capillary 330 provides a design solution for a fused silica capillary intended to function at a wavelength of 488 nanometers, although the design prescription could be optimized at any wavelength for which the transmission properties of the selected material are acceptable. The rays 342 of the interrogation beam may be collimated, or alternatively, the design may be modified to function with non-collimated interrogation radiation. In the preferred embodiment, collimated radiation impinges upon the entrance surface 334a. The acylindrical nature of surface 334a is obtained by evaluating the expression of Equation (1) with coefficients appropriate to this embodiment as follows. In FIG. 10, the optical axis 362 is the reference for the zonal coordinate 354 used in the polynomial expansion in Equation (1). The curvature parameter C for acylindrical surface 334a is given as: 18.19. The conic eccentricity parameter K has a value of 0.442, while coefficients D, E, F, and G are set to zero in this preferred embodiment.

The input interrogation energy 342 is refracted by the entrance surface 334a and then encounters the interior surface 336 of capillary 330 at an axial separation distance of 0.0865 mm. Conforming to the law of refraction that is recognized by those skilled in the optics art, this energy passes into sample passageway 338, where it interacts with the agent therein—in this design example, water. The diameter of the sample passageway 338 is specified to be 0.075 mm. The interrogation energy passes through the bore a distance of 0.075 mm along the axis 362, and then again encounters the interior surface 336. Again traveling in fused silica, the radiation travels a distance of 0.0265 mm through the silica, and encounters the planar rear surface 344 of capillary 330. In this case the surface is uncoated, so that the excitation radiation passes substantially unhindered through it and out of the capillary body.

In FIG. 11, the constructional parameters are identical to those of the capillary 330. Rear surface 344 is further made reflective utilizing any of several existing coating processes known to those skilled in the art. First portion 340 of body wall 332 is shaped to substantially focus incident interrogation radiation 342 at reflective surface 346. If incident radiation 342 is precisely focused (in this Y-Z plane) at rear surface 344, the ray paths become inverted upon reflection, for example rays 342I reflects as 352R. The reflected energy is returned a distance of 0.0265 mm back to interior surface 336 of sample passageway 338. This energy is refracted into the capillary bore to again interact with the agent therein. In the fifth preferred embodiment, (1) decentering the bore, (2) modifying the shape of the entrance surface, (3) rendering the rear surface reflective all cooperate to improve interrogation efficiency by a factor of approximately 2.8X compared to a conventional transparent coaxial cylinder capillary, operating in single-pass mode. If the combined improvements in interrogation and signal collection efficiency are considered, such a design is capable of yielding a net performance improvement approaching 4.5X.

The above-described interpretations of the present invention represent distinct and unique solutions in a continuum of solutions in the design terrain of capillary configurations non-symmetric about the capillary longitudinal axis. In the design of an advanced capillary configuration, it is important to consider the cumulative effects of the design features upon both interrogation and signal collection performance. A design that is very efficient for delivery of interrogation radiation, but performs poorly in signal delivery, may not be optimal overall. The present invention further contemplates combining and balancing the enhancements described above in a capillary design that utilizes interrogation radiation much more effectively, and delivers signal radiation for collection much more effectively than a standard capillary employing concentric cylindrical outer and inner surfaces.

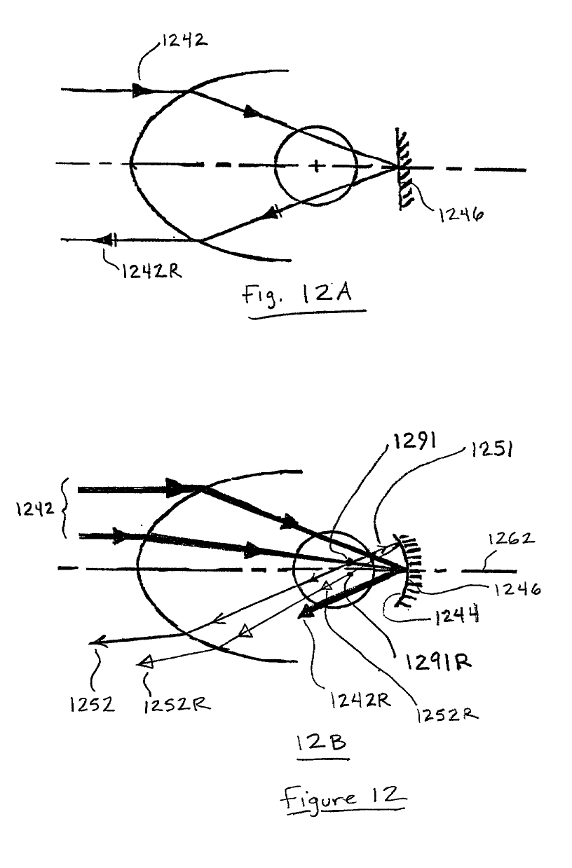

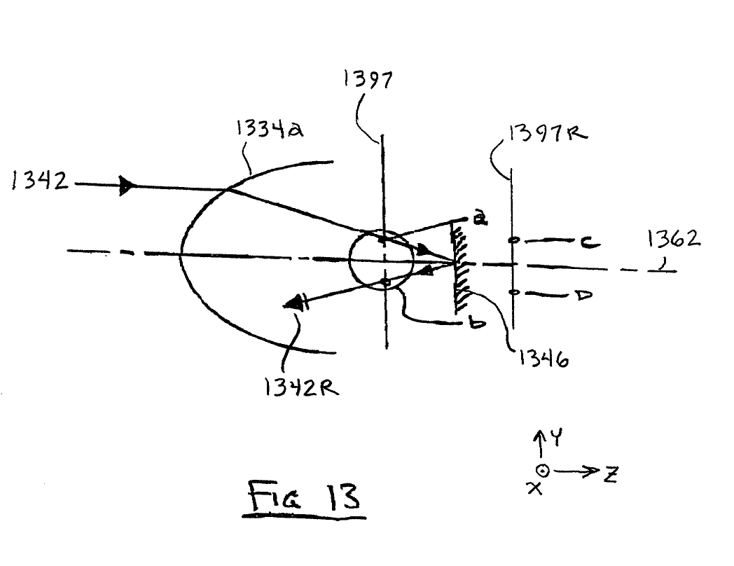

If capillary 330 of FIG. 10 is enhanced by making the outer wall 344 reflective, then the interrogation energy 342 focused upon the rear outer surface 344, will be returned with no added aberration, and with the ray paths reverted (top to bottom) to illuminate the opposite side of capillary bore 338. Since the excitation beam will be focused at rear surface 344, the footprint on that surface is exceedingly small, and the return ray paths will be substantially independent of the curvature of rear surface 344. This is very convenient, because it permits rear surface characteristics to be chosen in such a way that other design considerations be addressed. If reflective rear surface 144 is made planar, as in FIG. 12A for example, this surface can be used as a mechanical reference for mounting and alignment. If rear surface 344 is made cylindrical and centered on a point within bore 338 on the symmetry axis, as in FIG. 12B, then rear-lobe signal energy 1251 from sourcepoint 1201 propagating toward the reflective rear surface 1246 will be retro-reflected back 1252R to join the front-lobe signal energy 1252 on its way out of the capillary and on toward the collection and detection optics, thereby nearly doubling the signal energy available for detection in this embodiment.

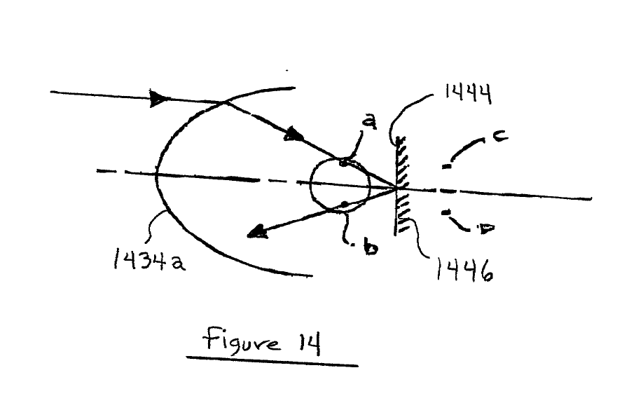

In any capillary design, the interrogation energy delivery and signal energy collection functions must be considered separately, since they are effectively separate optical systems. In FIG. 13, for example, the flat rear surface serves to aid in alignment and positioning of the capillary. However, as the interrogation beam through “a” scans across the capillary bore, the reflected interrogation energy illuminates a location on the opposite side of the bore at “b”, at an equal but opposite distance from the optical axis 1352. The resulting illuminated “satellite” signal source “b” can form a separate signal image at the detector location, requiring that any apertures present be sized to accommodate the parent and satellite images. These effects must be considered carefully, as vignetting of signal energy or non-uniform detector response can cause these two separate signal sources to generate false signal information.

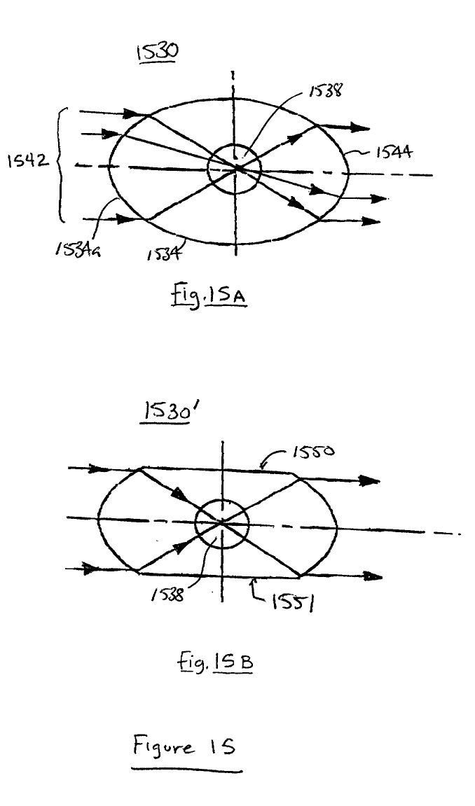

An additional complication of using a reflector on this swept excitation arrangement, relative to the conventional transparent capillary with single-pass interrogation, is that this design creates a total of four effective signal radiation sources, shown in FIGS. 13 and 14. Two of these, “a” and “b” in FIG. 13, radiate directly out the entrance surface 1334a of the capillary tube, while for a conventional capillary, only sourcepoint “a” would be active. Two other “virtual” signal source locations, created by reflection, lie some distance behind the reflector 1346 and the real source locations, and radiate the reflected signal energy back toward the collection optics. These two virtual sources, “c” and “d” in FIG. 13, are not imaged to the same (X-Y) plane 1397 as the images of “a” and “b”; they are imaged to another depth (Z dimension) 1397R. Thus their images, formed by the detection optical train, may be larger than those of the parent emission sources, which might cause the detection system to read the “a” and “b” signals differently from the “c” and “d” signals. When the combined source depth exceeds the depth of focus tolerance of the detection optical system, diminished or false signals can be a result.

Referring now to FIG. 14, a modification to this design approach involves repositioning the flat rear surface to a location closer to the bore, thereby thinning the rear wall of the capillary tube. If this is done, and the shape of the window surface 1434a is adjusted slightly to maintain focus on the rear surface 1444, the virtual signal images “c” and “d” will be more nearly in-plane with respect to the parent sources “a” and “b”. This could be an advantage for optimizing the performance of the optical train that collects and images the signal from the capillary, for example by increasing the system tolerance to capillary defocus. Or, in the case of confocal detection, this improvement could allow the confocal pinhole size to be reduced, with attendant improvement in signal to noise performance of the detection system. The present invention therefore contemplates providing a thin rear portion 132a of tubular body wall 132 so that any signal reflected by reflective surface 1444 appears to emerges from the same depth within the capillary 1430. By way of illustration and not of limitation, the spacing between the center 1431 of bore 1438 and 1446 reflective wall may be made less than one half the average width of bore 1438. Alternatively, the distance from bore 1438 and its virtual (reflected) image may be made less than one third the average outside diameter of the capillary.

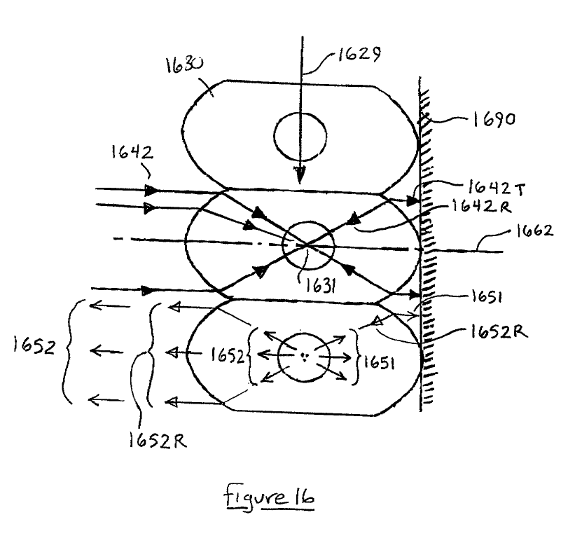

FIG. 15A depicts another example of an acylindric capillary 1530 of the present invention. In this example, the entrance and exit surfaces of the capillary are shaped identically and disposed at the same distance from the capillary bore 1538. Capillary 1530 includes identically shaped entrance and exit surfaces 1534a and 1544, respectively. Entrance surface 1534a and its spacing relationship to capillary bore 1538 are optimized for some combination of improved efficiency in interrogation and signal energy delivery. The bilateral symmetry of this design reduces handling and mounting problems in assembly, since the capillary may be positioned in either orientation for proper function. Referring now to FIG. 15B, capillary 1530′ includes opposed planar side surfaces 1550 and 1551 so as to aid in preserving rotational alignment when capillaries 1531 are mounted in closely spaced arrays. Furthermore, flattening the sides of a curved capillary 1530 allows higher packing density within an array of capillaries, thereby improving the duty fraction of an interrogation beam scanning an entire array. While FIGS. 15A and 15B show the symmetrical case of capillary of FIG. 6C, the front-to-back symmetry could also apply to any capillary of the present invention, such as those shown in FIG. 6 or FIG. 9.

FIG. 16 depicts an array of capillaries 1630 formed similar to capillary 1530′. Capillaries 1630 are mounted with their rear surfaces 1644 in contact with a planar reflective surface 1690. In this arrangement, substantially all the collimated interrogation radiation 1642 delivered in this Y-Z plane exits the capillary as radiation 1642T in collimated fashion, encounters planar reflective surface 1690 aligned square to axis 1662, and is retro-reflected back on itself as radiation 1642R to reenter capillary 1630 and refocus to the center of the capillary bore 1631. Corresponding signal radiation from the center of the bore is directed into first portion 1640 as front-lobe radiation 1652, and rear lobe signal energy 1651 is directed into the second portion 1641 of the body wall. The rear lobe energy exits the capillary in a collimated condition and is reflected by the reflector 1690 as reflected radiation 1652R. Then both lobes of signal radiation 1652 will ultimately exit the capillary from the surface 1634a through which interrogation radiation 1642 entered. Planar reflector surface 1690 serves to nearly double the strength of both interrogation and signal energy, as well as to aid in the positioning of all capillaries in an array at an equal distance from the collection optics, thereby minimizing defocus problems. This doubled signal collection would apply as well with interrogation rays 1629, directed from the side of the capillaries, although without the benefit of double-pass interrogation.

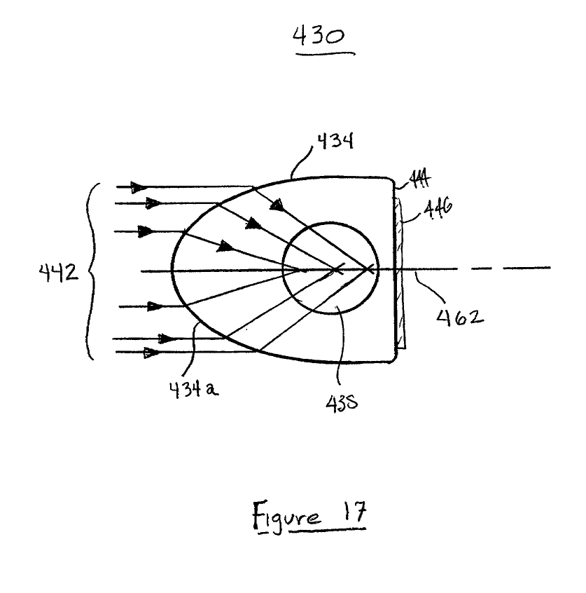

FIG. 17 depicts still another embodiment of the present invention. Capillary 430 includes a shaped exterior surface 434 which delivers interrogation radiation 442 so that it is distributed substantially uniformly throughout the depth of bore 438. Entrance surface 434a is specifically designed to create a balance of aberration that will homogenize the distribution of interrogation radiation in bore 438. This is in contrast to other designs, as in FIGS. 6B-D, where the interrogation radiation is focused to emphasize sample located at selected depths within the bore.

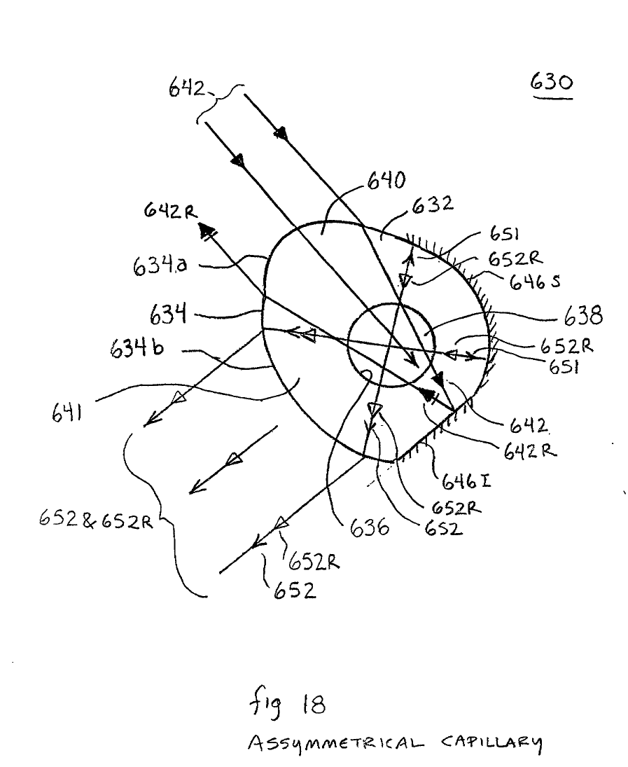

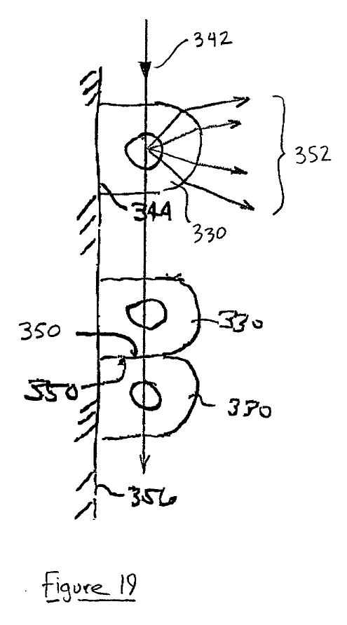

FIG. 18 depicts a capillary 630 of the present invention to provide scanned interrogation swept across the core, with the efficiencies of double-pass interrogation and maximized dwell time on the core and high duty fraction of the scan; along with high-NA collection of the signal radiation in concert with the reflected signal radiation. Interrogation energy 642 is directed at sample passageway 638 from a first direction, passing through a first window portion 640, and in which signal energy 652 is collected and coupled out of the capillary through a second window portion 641, positioned at an angle from the first window. In detail, Capillary 630 includes an elongate tubular body wall 632 having an exterior surface 634 and a substantially cylindrical interior surface 636. Interior surface 636 defines an elongate cylindrical sample passageway 638 for containment of a sample agent. Capillary body wall 632 includes a first portion 640 shaped in accordance with the present invention to refract incident radiation 642 into sample passageway 638. Body wall 632 also includes a second portion 641 shaped in accordance with the present invention to refract energy originating from within the sample passageway 638 towards a collecting optical system positioned at roughly ninety degrees from the path of the incident radiation 642. The action of the reflective surface is likewise in two parts. Portion 6461 reflects interrogation radiation back into the core, providing the benefits of double-pass interrogation. Portion 646S reflects rear-lobe signal radiation 651 back 652R through the core 638 to exit the capillary in concert with the front-lobe signal radiation 652, thus providing nearly double the signal radiation for detection.

Both first portion 640 and second portion 641 of the body wall provide regions of non-uniform thickness about sample passageway 638 to aid in the refraction of both the interrogation radiation and the signal radiation, respectively. First and second portions 640 and 641 of body wall 632 include an exterior surface 634a and 634b, respectively, which are desirably shaped and specified in accordance with Equation 1, using appropriate coefficients for the two distinct optical functions that these windows perform. This decoupling of the two optical functions, interrogation and signal collection, allows the designer greater freedom to optimize the whole, by optimizing independently the two refractor-reflector pairs. As well, greater design freedom is available for optimizing the two optical trains that handle separately the interrogation and signal radiation.

FIG. 20 depicts even still another capillary 730 of the present invention. Capillary 730 includes a parabolic rear surface 744 having a parabolic reflector 746 mounted thereon. Parabolic reflector is shaped about a focal point located within sample passageway 738. An interrogation beam 742 works with maximal duty fraction and dwell time, and double pass interrogation is active for a significant portion of the scan across the capillary. The collection of signal radiation 752 captures a large solid angle from sourcepoints within 738 bore, exceeding the limits of conventional collection optics for scanning capillaries. Optical gain exceeding a factor of 10 is achievable with this arrangement, compared to conventional interrogation/detection arrangements. As well, the depth of focus is greatly enhanced, due to the collimated condition of the signal rays leaving the bore in the transverse plane.

The optical analysis chambers of the present invention may be formed using ordinary manufacturing techniques. For example, when the optical analysis chamber is to take the form of a capillary as is typically employed in electrophoretic analyzers, conventional capillary-forming techniques are applied. One method for forming a capillary of the present invention includes fabricating a preform having the cross-sectional shape of the desired finished capillary. The capillary preform is then drawn so as to reduce the dimensions, without significantly altering the geometric properties, to the size of a capillary. It is also contemplated that capillary wall material may be removed from or added to the preform to impart the optical and mechanical properties as taught herein. When adding material to a preform, the present invention further contemplates that material having different optical properties than the preform material, such as refractive index, absorption or dispersion properties, may be employed to further refine the optical characteristics of the finished optical chamber. Moreover, it is well known in the art to coat the capillary as it is being drawn with a protective coating to protect the surface of the capillary and provide strength. Coating materials may include, but are not limited to, organic materials, polymers, and polyimids. It is further contemplated by the present invention that such coatings are removed from portions of the optical chamber so as not to interfere with the interrogation radiation or the emitted signal coupling. When such coating are applied to portions of the outer surface of the capillary that are used for optomechanical alignment purposes, the present invention contemplates the coating will maintain the provided surface so as not to compromise this alignment function. It is also anticipated that certain applications can make use of the capillary without any portion of the coating being removed, so that the interrogation/detection occurs through the applied protective coating, thereby taking advantage the coating shape, which may conform to the capillary shape, or form to a different shape than the underlying glass, or provide additional thickness or nonuniform thickness about the capillary body.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. An optical analysis chamber, comprising
An optically transmissive elongate tubular body having an elongate tubular body wall including an interior surface and an exterior surface, said interior surface of said body wall defining an elongate sample passageway for containing a sample material;
Wherein said body wall further includes a first optically transmissive window, said window having a curved exterior surface portion, through which optical radiation passes, said window having a non-uniform thickness about the sample passageway selected so as to optimize optical coupling therewith for analyzing said sample material.

2. The optical analysis chamber of claim 1, wherein said first window further
comprises a substantially curved interior surface portion.

3. The optical analysis chamber of claim 2, wherein said tubular body is an electrophoresis capillary.

4. The optical analysis chamber of claim 2, wherein said exterior surface of said first window defines an optical interrogation beam transmission surface having a substantially semi-cylindrical shape.

5. The optical analysis chamber of claim 2, wherein the longitudinal axis of said sample passageway is offset from the longitudinal axis of said tubular body.

6. The optical analysis chamber of claim 2, wherein said exterior surface of said window defines an optical interrogation beam transmission surface having a substantially acylindrical shape.

7. The optical analysis chamber of claim 2, wherein incident optical radiation passing through said window is directed through said sample passageway and is brought substantially to focus at a location near said exterior surface of said tubular body beyond said sample passageway.

8. The optical analysis chamber of claim 2, wherein incident optical radiation passing through said window is directed through said sample passageway and is brought substantially to focus at a location near said interior surface of said tubular body beyond the center of said passageway.

9. The optical analysis chamber of claim 2, wherein incident optical radiation passing though said window is directed through said sample passageway and is brought substantially to focus at a location within said sample passageway.

10. The optical analysis chamber of claim 2, wherein incident optical radiation passing through said window is directed through said sample passageway and is brought substantially to focus at a location near said interior surface of said tubular body before the center of said passageway.

11. The optical analysis chamber of claim 2, wherein incident optical radiation passing though said window is directed to substantially focus about the center of said passageway.

12. The optical analysis chamber of claim 2, wherein a portion of said exterior surface includes a reflective coating so as to redirect optical radiation towards said sample passageway.

13. The optical analysis chamber of claim 2, wherein a portion of said exterior surface of said tubular body is formed to be substantially curved.

14. The optical analysis chamber of claim 2, wherein said exterior surface of said tubular body further includes at least one facet for cooperatively aligning adjacent said optical analysis chambers within an array of said optical analysis chambers.

15. The optical analysis chamber of claim 2, wherein said exterior surface of said tubular body further includes a pair of opposed planar facets for cooperatively aligning adjacent said optical analysis chambers within an array of said optical analysis chambers.

16. The optical analysis chamber of claim 1, wherein said body wall further includes a portion functioning as an second window selected to optimize optical coupling of information-carrying radiation out of said passageway

17. The optical analysis chamber of claim 16, wherein said first window is distinct from said second window.

18. The optical analysis chamber of claim 16, wherein said first window is substantially orthogonally oriented with said second window.

19. The optical analysis chamber of claim 2, wherein the cross-section of said tubular body is bilaterally symmetric.

20. The optical analysis chamber of claim 2, wherein the cross-section of the external surface of said tubular body has no axis of symmetry.

21. The optical analysis chamber of claim 17, wherein said tubular body wall further comprises a third window selected to optimally couple radiation therethrough.

22. A method of forming an optical analysis chamber comprising the step of: shaping an elongate tubular body wall having a curved exterior surface and a substantially curved interior surface defining a fluid sample passageway such that said exterior and interior surfaces cooperate to optimize optical coupling efficiency for radiation directed through said body wall.

23. The method of claim 22, further comprising the step of shaping said curved exterior surface and said substantially curved interior surface such that said exterior and interior surfaces cooperate to maximize optical coupling efficiency for radiation directed through said body wall from said passageway.

24. The method of claim 23, further comprising the step of shaping said exterior surface of said body wall so as to define a first optical window through which an optical interrogation beam passes, said window being rotationally asymmetric about the longitudinal axis of said passageway.

25. The method of claim 24, further comprising the steps of
providing a preform of said tubular body; and
drawing said preform to reduced dimensions.

26. The method of claim 25, wherein said step of providing a preform further comprises the step of providing an elongate tubular body wall having a substantially cylindrical exterior surface and a substantially cylindrical interior surface.

27. The method of claim 25, further comprising the step of removing material from said preform.

28. The method of claim 26, further comprising the step of adding additional optically-transmissive material to said preform.

29. The method of claim 25, further comprising the step of forming a portion of said exterior surface of said body wall to be substantially planar to assist in alignment with an optical source.

30. The method of claim 26, further comprising the step of forming a portion of said exterior surface of said body wall to be substantially planar to assist in alignment relative to an optical radiation collector.

31. The method of claim 30, further including the step of forming said exterior surface of said first window so as to direct optical radiation to converge upon a location near the center of said sample passageway.

32. The method of claim 26, further including the step of forming said exterior surface of said window to be acylindrical.

33. The method of claim 22, further including the step of positioning said tubular body within a holder providing facets for cooperatively engaging said exterior surface of said tubular body so as to properly align said tubular body within said holder.

34. The method of claim 24, further including the step of forming a reflective surface opposite said fluid passageway from said first window to redirect radiation towards said sample passageway.

35. The method of claim 31, wherein said step of forming a reflective surface further includes forming a substantially planar reflective surface.

36. The method of claim 31, wherein said step of forming a reflective surface further includes forming a substantially curved reflective surface.

37. The optical analysis chamber of claim 22, wherein said tubular body wall is formed from a material having a refractive index in the range from about 1.4 to about 2.0.

38. The method of claim 34, further including the step of forming portion of the tubular body wall so that signal reflected by said reflective surface appears to emerge from the same depth within the capillary.
